(19) United States
(12) Patent Application Publication
(10) Pub. No.: US 2006/0027178 A1
(43) Pub. Date: Feb. 9, 2006

(54) Disposable pet feeding bowl

(76) Inventor: Beatrice R. Stephens, Ft. Lauderdale, FL (US)

Correspondence Address: LITMAN LAW OFFICES, LTD, PO BOX 15035, CRYSTAL CITY STATION, ARLINGTON, VA, 22215, US

(21) Appl. No.: 11/188,790

(22) Filed: Jul. 26, 2005

Related U.S. Application Data
(60) Provisional application No. 60/591,859, filed on Jul. 29, 2004.

(51) Int. Cl. A01K 5/01; A01K 1/10

(52) U.S. Cl. 119/61.56; 119/61.5

(57) ABSTRACT

The disposable pet feeding bowl is a pet-friendly food container that can store food or water without losing form. The bowl has a bowl cavity composed of a substantially leakproof flexible sheet of material, and has a flexible rim that allows an attached closure element of substantially leakproof material to flip up above the rim and bowl cavity. When the closure element is flipped up, the seal is above the bowl cavity and allows for easy bowl closing by a reclosable seal disposed along the peripheral edge of the closure element. The bowl is made of specially coated or treated leakproof paper, or other flexible substantially leakproof and resilient material, and comes in a variety of sizes, colors and patterns.

### CROSS-REFERENCE TO RELATED APPLICATION

This application claims the benefit of U.S. Provisional Patent Application Ser. No. 60/591,859, filed Jul. 29, 2004.

### BACKGROUND OF THE INVENTION

1. Field of the Invention

The present invention relates to animal feeding containers, and more specifically to a disposable pet feeding bowl.

2. Description of the Related Art

Pet food is most often sold in bulk containers for dispensing individual servings in durable, reusable bowls. Often the closures for bulk food containers are not air tight, so that the food may spoil over time. In addition, durable pet bowls must be cleaned between feedings. Further, many pets eat their food from the bowl in many small portions spaced out over time, so that the food can become dried out through exposure to the air before the pet's appetite is satisfied. Also, when the pet is brought along on trips away from home, it is inconvenient to transport both the bulk food container and a durable bowl. Some attempts have been made to address these problems. For example, French Patent No. 2,778,891, published Nov. 26, 1999, discloses a disposable pet food bowl with a single serving of pet food secured therein by a tear-off film seal.

None of the foregoing patents or publications discloses the present invention as claimed. Thus, a disposable pet feeding bowl solving the aforementioned problems is desired.

### SUMMARY OF THE INVENTION

The disposable pet feeding bowl is a food container that can store dry or liquid pet foods without spoilage. The bowl has a flexible rim that allows the sides to flip up above the food cavity, i.e., above the center of the bowl. When the sides are flipped up, the zipper and lining are at the top and allow for easy bowl closing, similar to a Ziploc® bag. The bowl is made of paper or other flexible material with non-leak coating substance, and comes in a variety of sizes, colors and patterns.

These and other features of the present invention will become readily apparent upon further review of the following specification and drawings.

### BRIEF DESCRIPTION OF THE DRAWINGS

FIG. 1 is an environmental, perspective view of a disposable pet feeding bowl according to the present invention.

FIG. 2A is a perspective view of a disposable pet feeding bowl according to the present invention with the flexible closure element in an open position, folded down around the bowl.

FIG. 2B is a perspective view of a disposable pet feeding bowl according to the present invention with the closure element sealed in a closed position over the bowl.

FIG. 3A is a side view of the disposable pet feeding bowl according to the present invention with the closure element in a closed position sealed over the bowl.

FIG. 3B is a side view of the disposable pet feeding bowl according to the present invention with the closure element unsealed and folded around the bowl.

FIG. 4 is a top view of the disposable pet feeding bowl according to the present invention with the closure element unsealed and folded over the bowl.

Similar reference characters denote corresponding features consistently throughout the attached drawings.

### DETAILED DESCRIPTION OF THE PREFERRED EMBODIMENT

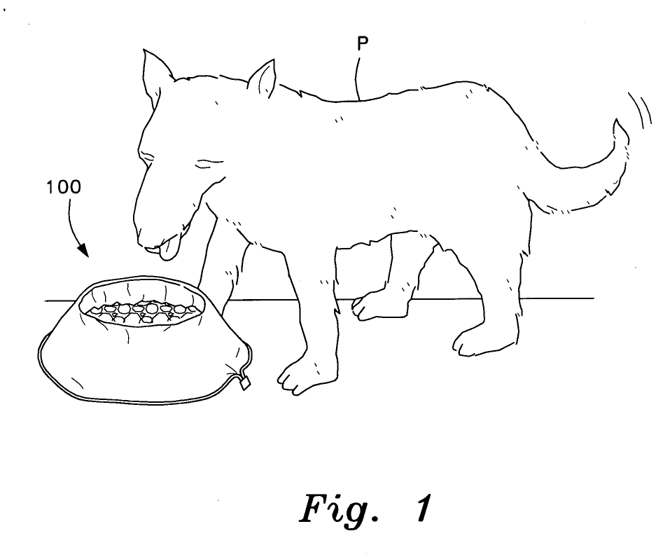

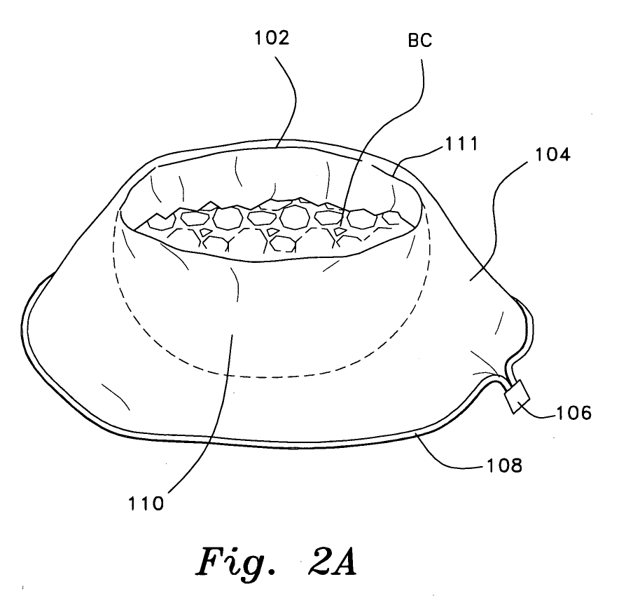

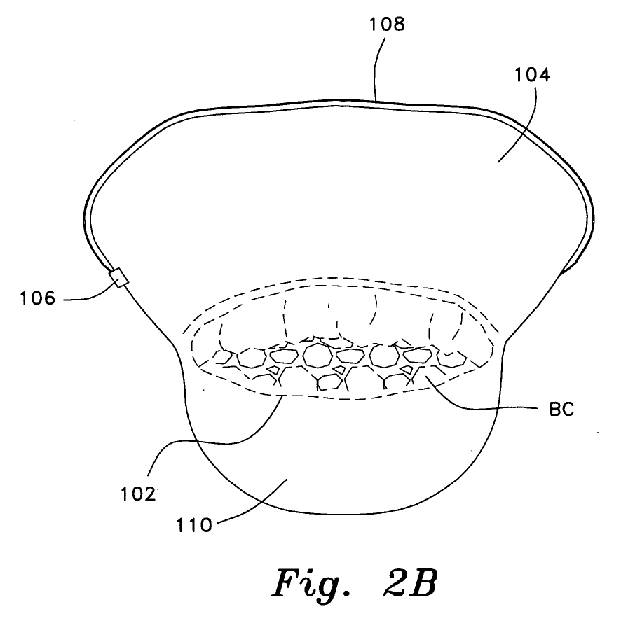

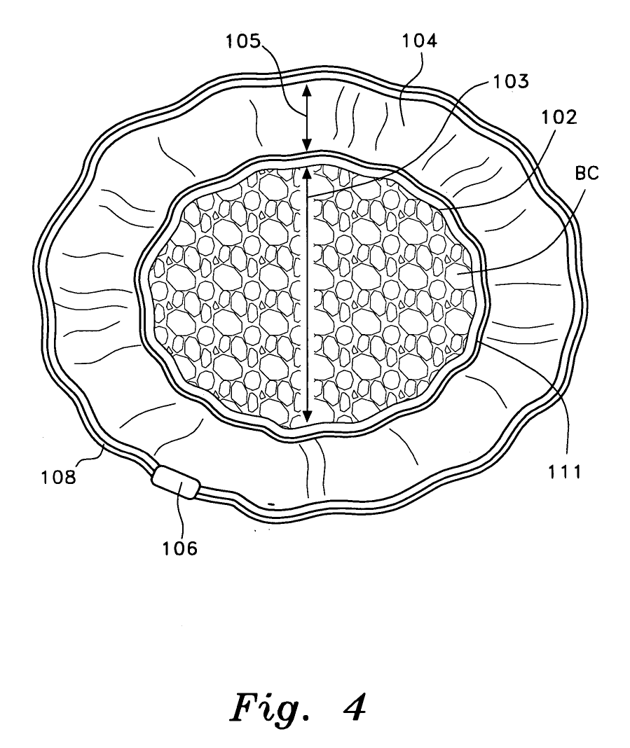

The present invention is a food container that can store dry or liquid pet food without spoilage. As shown in FIG. 1, pet P can eat food or drink water that is contained in open disposable bowl 100. Referring to FIGS. 2A and 4, it is shown that the present invention, disposable bowl 100 comprises a flexible and preferably resilient sheet of material defining a bowl cavity BC for food.

A flexible indentation 111, or a plurality of flexible indentations, at a top of the bowl cavity BC defines a flexible and preferably collapsible bowl rim 102. Additionally, a sealable closure element 104 is disposed along the bowl rim 102. The closure element 104 may be a separate cylindrical sheet of flexible material (or two flat sheets joined together along their side edges to form a hollow cylinder) attached to the bowl rim, or the closure element 104 may be formed in one piece with the same sheet of material defining the bowl cavity BC.

Sealing means are circumferentially disposed on the closure element 104, preferably at a distance from the rim 102 that is close to the peripheral edge of the closure element 104 at a circumferential displacement indicated by arrow 105, as shown in FIG. 4. The closure element 104 should be of sufficient dimension to completely cover the bowl cavity BC when the closure element is flipped up, i.e., unfolded and extended above the bowl cavity BC. The sealing means is resealable, i.e., has the capability to be resealed a plurality of times.

Referring to FIG. 2A, it should be noted that any shape of bowl 100 that is generally of sufficient concavity to hold solid or liquid contents, such as the shape of bowl body 110, is within the scope of the present invention. However, a preferable bowl shape may define a quadric surface, such as a semiellipsoid or hemisphere. The shape of bowl cavity BC may preferably be hemispherical for most applications. However, bowl shape parameters, such as bowl depth, bowl diameter, or in the case of non-circular rim circumferences, bowl minor axes dimension (as indicated by arrow 103 in FIG. 4), as well as other bowl dimensions, may be optimized for the particular morphology of the type of pet P that may use the bowl 100.

As shown in FIG. 2B, the flexible rim 102 of the bowl allows the closure element 104 to flip up above the rim 102 and bowl cavity BC. When the closure element 104 is flipped up, the sealing means, such as, for example, a zipper head 106 and zip slide track 108, are at the top and allow for easy bowl closing, like a Ziploc® bag. It is within the scope of the present invention to include other sealing means, such as adhesive, tongue and groove, and the like. Each of the sealing mechanisms discussed above is designed to seal off the bowl 1 00 sufficiently so that the bowl contents may be preserved without spillage or spoilage.

The bowl 100 is made of moisture impermeable, leak-resistant paper or other flexible, resilient, and leak-resistant material. A non-leak coating substance may be applied to the paper or other material to further enhance the no leak properties of the bowl 1 00. Preferably, the bowl material should be made of a recyclable composition. The paper or other bowl material may be made with designer scented flavors, e.g., the scent of human consumable food, to attract pets and direct their appetite. The bowl geometry, i.e., shape of bowl 100 is made so that bowl 100 can be packed in an easy-to-open and convenient packaging that holds multiple single bowls, preferably 30 or more.

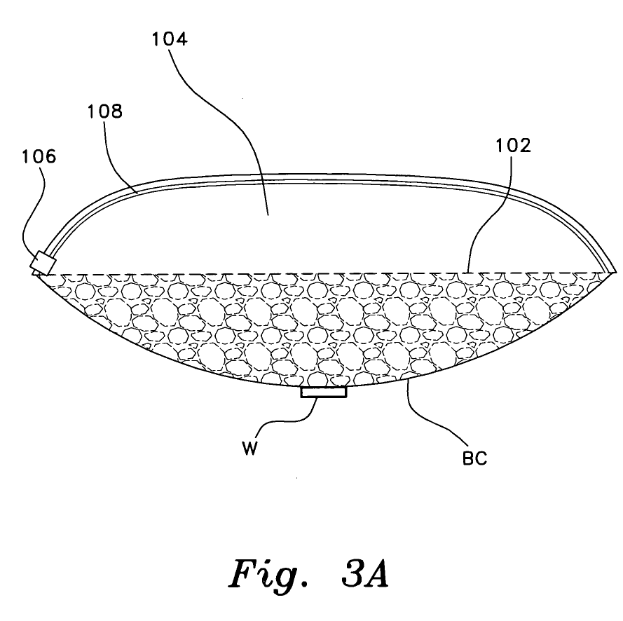

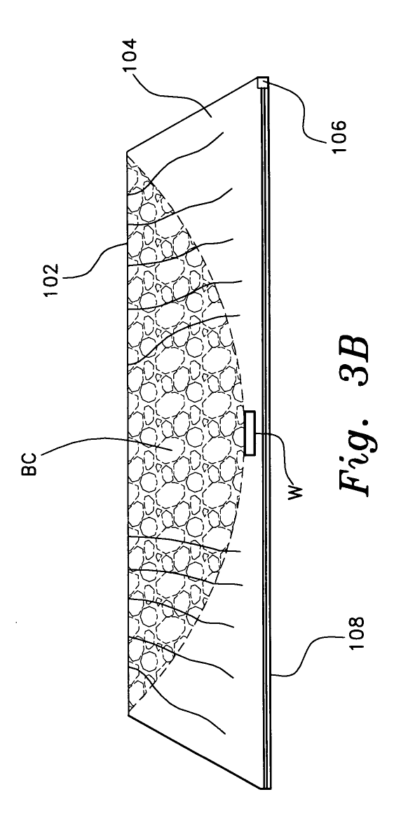

Additionally, the bowl may have adhesive or, as shown in FIG. 3A, a ballast or weight W in the center of the bowl to keep the bowl from moving when being used by a pet. FIG. 3B shows how the weight W may stabilize the bowl cavity BC with closure element 104 in the open, folded down position. The bowl may come in a variety of sizes, colors, patterns and shapes.

Usage of the bowl comprises opening a package of bowls and removing a disposable bowl. For a review of bowl structure, refer to FIGS. 2A, 2B, and 4. Hands are placed on opening end of bowl 100 and the sides of the bowl are separated, i.e., the bowl rim 102 is opened, thus opening bowl cavity BC, and the closure element 104 is separated by unsealing the closure element sealing means and folding the ring 104 down. The bowl is placed on a flat surface with the weight W, or adhesive that is in the center of the bowl. The food is then poured into the disposable bowl 100. Once the meal has been consumed, the disposable bowl 100 is ready to be thrown into the trash.

If a meal has been partially consumed, leftovers may be preserved by resealing the bowl 100. The user presses down on indentations 111 in the rim 102 and flips the closure element 104 up above the food cavity. The closure element 104 above cavity BC is then resealed using the zipper 106 and slide track 108, or adhesive or other type sealing means disposed on the closure element 104. To unseal the closure element 104, the zipper 106 is unzipped to open the slide track 108. Thumbs are then placed on the inside of bowl and fingers are pressed underneath indentations 111 of the flexible rim 102 to flip the ring 104 of the bowl 100 down. The unsealed ring 104 then faces down, as the rim 102 gives the bowl its form.

It is to be understood that the present invention is not limited to the embodiment described above, but encompasses any and all embodiments within the scope of the following claims.

I claim:

1. A disposable pet feeding bowl, comprising:
a substantially leak proof flexible sheet of material defining a bowl cavity; the sheet at least one flexible indentation defining a flexible bowl rim extending around a top end of the cavity;
a closure element disposed along the flexible bowl rim, the closure element being foldable along the indentation into an open position so that the closure element surrounds the bowl, and foldable into a closed position above the bowl cavity; and
sealing means disposed circumferentially on the sealable closure element for sealing the closure element for storage of and later access to pet food within the bowl cavity.

2. The disposable pet feeding bowl according to claim 1, wherein the bowl cavity has a substantially hemispherical shape.

3. The disposable pet feeding bowl according to claim 1, wherein the sealing means comprises a zipper locking mechanism.

4. The disposable pet feeding bowl according to claim 1, wherein the sealing means comprises a tongue and groove locking mechanism.

5. The disposable pet feeding bowl according to claim 1, wherein the sealing means comprises adhesive.

6. The disposable pet feeding bowl according to claim 1, wherein the sealing means is resealable.

7. The disposable pet feeding bowl according to claim 1, wherein the sheet of material defining the bowl cavity comprises designer scented flavors adapted for attracting pets.

8. The disposable pet feeding bowl according to claim 1, further comprising a weight disposed below the bowl for preventing the bowl from moving when being used by the pet.

9. The disposable pet feeding bowl according to claim 1, wherein the bowl sheet of material is made of a recyclable material.
